(19) United States
(12) Patent Application Publication
(10) Pub. No.: US 2008/0168620 A1
(43) Pub. Date: Jul. 17, 2008

(54) Arrangement having a hinge, in particular a furniture hinge

(76) Inventor: Claus Hammerle, Dornbirn (AU)

Correspondence Address: WENDEROTH, LIND & PONACK, L.L.P., 2033 K STREET N. W., SUITE 800, WASHINGTON, DC, 20006-1021, US

(21) Appl. No.: 12/073,155

(22) Filed: Feb. 29, 2008

Related U.S. Application Data
(63) Continuation of application No. PCT/AT2006/000331, filed on Aug. 4, 2006.

(30) Foreign Application Priority Data
Sep. 1, 2005 (AU) A 1430/2005

(51) Int. Cl. E05F 5/04

(52) U.S. Cl. 16/85

(57) ABSTRACT

The invention relates to an arrangement comprising a hinge, in particular a furniture hinge, and a damper (7). The damper (7) or damper housing (5), which supports the damper (7), is placed on the hinge by means of at least one securing device (11) which is elastic in places. The securing device (11) comprises at least one first supporting part (12) which is essentially rigid and at least one second supporting part (13) which is essentially springy or spring-loaded.

The invention concerns an arrangement comprising a hinge, in particular a furniture hinge, and a damper, wherein the damper or a damper housing carrying the damper can be fitted onto the hinge by means of a fixing device which is at least region-wise elastic.

An arrangement of the general kind set forth is already known from the Austrian patent bearing the No 410 118.

The object of the invention is to further improve an arrangement of the general kind set forth in such a way that the damper or the damper housing on the one hand can be easily fitted in place and can preferably also be easily removed, but on the other hand a firm hold in the fitted condition is also guaranteed.

In accordance with the invention that is achieved in that the fixing device comprises at least one substantially rigid first support portion and at least one substantially resilient or spring-loaded second support portion.

In that case the substantially rigid first support portion forms a fixed fitment portion. The substantially rigid structure is so designed in that case that, even under a severe loading on the damper in operation, no deformation of the first support portion, as is essential for function, occurs. The resilient or spring-loaded second support portion allows the damper or the damper housing to be fitted on to the hinge preferably in the form of a snap connection, preferably by latching engagement. Removal of the damper is effected in a corresponding fashion by the second support portion being elastically deformed against its spring loading.

The spring loading acting on the second support portion desirably acts in the direction away from the first support portion. In addition there can also be provided a further third support portion which prevents unwanted lateral displacement or pivotal movement.

The fixing device can be arranged both on the hinge and also on the damper or damper housing, preferably being fixed in position or formed integrally thereon. Accordingly the invention also concerns a hinge suitable for such an arrangement, as well as a damper suitable for such an arrangement, and a damper housing suitable for such an arrangement with a corresponding fixing device.

Further details and features of the present invention will be apparent from the specific description hereinafter. In the drawing:

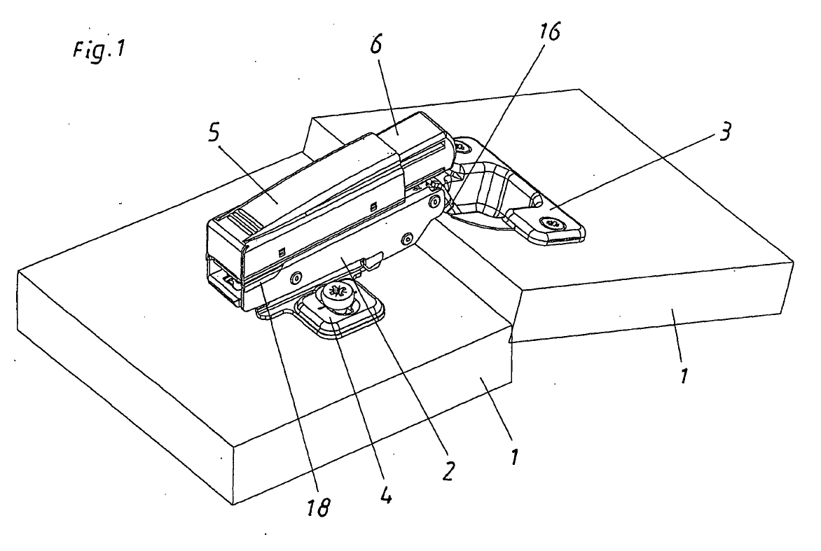

FIGS. 1 through 5 show a first embodiment according to the invention, and

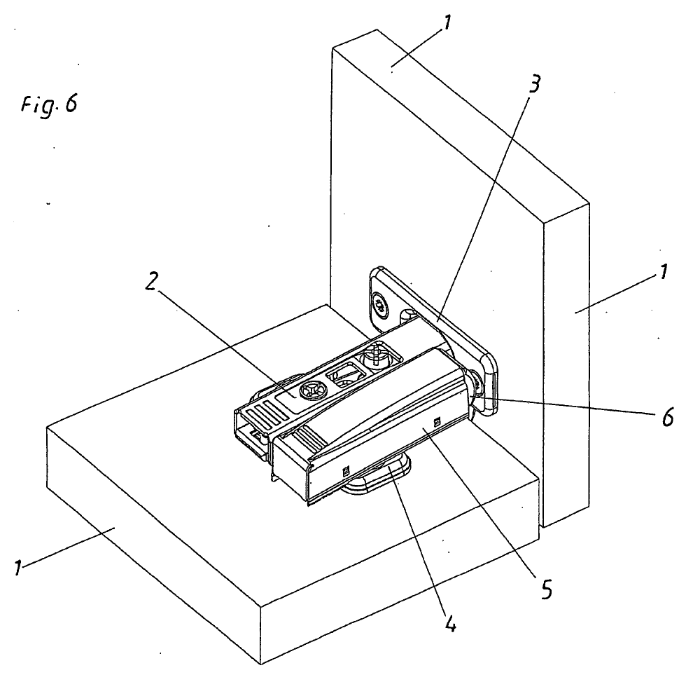

FIGS. 6 through 8 show three further embodiments according to the invention.

FIG. 1 shows an arrangement of a furniture hinge comprising a damper housing 5 which is fitted onto the hinge arm 2 and in which a plunger 6 is displaceably supported. The damper itself is supported within the plunger 6 and the housing 5 and is not visible in this view. The furniture hinge which is known per se in the state of the art has, as fitment portions, besides the hinge arm 2, a hinge cup 3 which is connected thereto by way of hinge levers 16. The hinge arm 2 is releasably fixed to a base plate 4 by way of a clipping mechanism which is also known per se. The base plate 4 and the hinge cup 3 are screwed to the furniture parts 1.

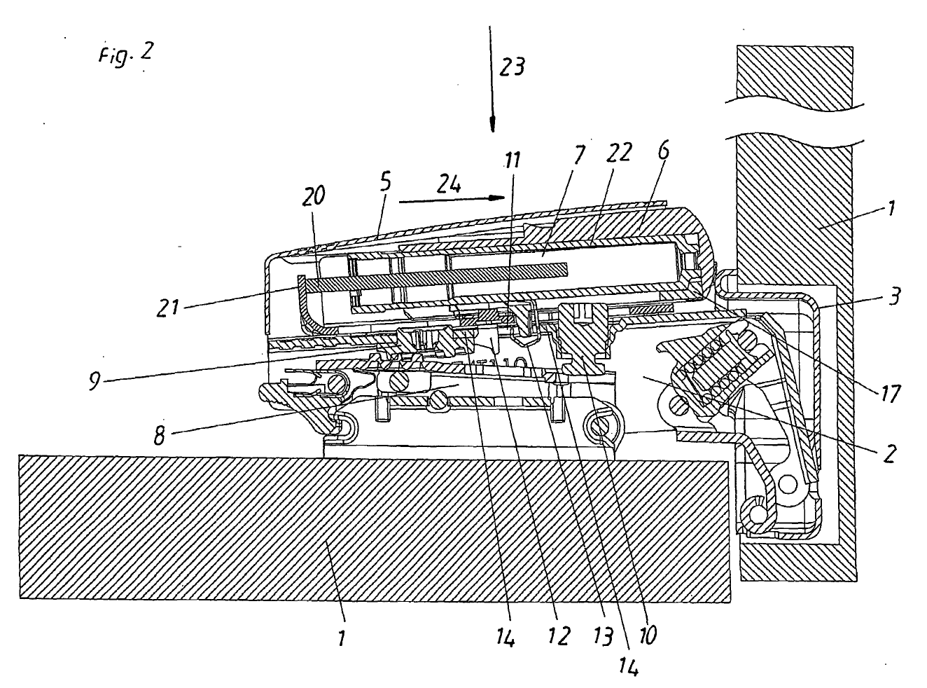

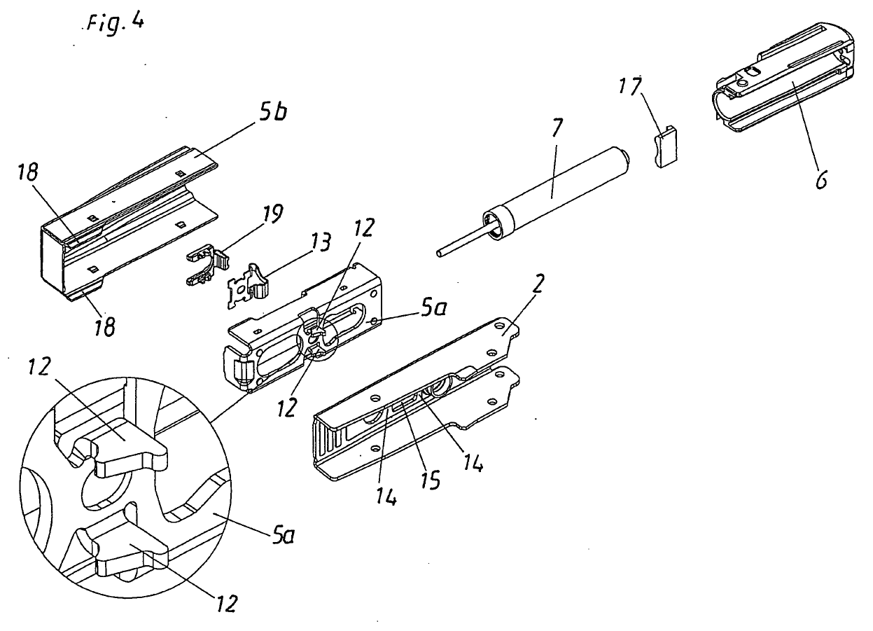

FIG. 2 shows a view in section through the arrangement of FIG. 1. It is possible to see here firstly the damper 7 which is supported internally in the plunger 6 and the damper housing 5. The illustrated embodiment involves a per se known linear damper filled with damping fluid. The invention however can also be embodied with other dampers such as for example rotational dampers. The piston rod 20 of the damper 7 is supported against a corresponding support wall 21 in the damper housing 5. The cylinder 22 of the damper 7 is supported in the plunger 6, with the interposition of a rubber buffer 17. The plunger 6 itself is guided by way of its groove-shaped openings in the lower portion 5a of the housing. As can be seen in particular from FIG. 4 the upper portion 5b of the damper housing 2 which is constructed in two parts covers the entire unit. In this embodiment the fixing device 11 according to the invention is secured to the lower portion 5a of the housing. In this case the two first support portions 12 which are of a hooked configuration are in this embodiment formed directly integrally on the lower portion 5a of the housing while the second support portion 13 which is substantially in the form of a spring tongue is fixed together with a further additional member 19 to the lower portion 5a of the housing by way of a screw means or rivet means or the like. The first support portion 12 and the second support portion 13, in the assembly position shown in FIG. 2 in which the damper 7 and the housing 5 are fitted onto the hinge, engage into an opening 15 defined by the edges 14 in the hinge arm 2. For fitting it in place, it is essentially sufficient to press against the damper housing 5 in the direction of the arrow 23, in which case the spring tongue of the second support portion 13 deforms to such an extent that the hooked first support portions 12 can also penetrate into the opening 15.

As soon as the fixing device 11 is sufficiently deeply pressed in the direction 23, the first support portions 12 engage behind the rear edges 14 while the spring tongue of the second support portion 13 holds the damper unit in position. In that case the spring tongue bears against the edge 14 of the opening 15, that is towards the cup, and thereby guarantees a play-free fit for the damper unit on the hinge arm 2. When the damper 7 is subjected in operation to a loading, with which the plunger 6 is pushed into the housing 5, the entire unit comprising the plunger 6, the damper housing 5 and the damper 7 are always loaded in the direction of the substantially rigid two first support portions 12. The rigid nature of the first support portions 12 ensures that the damper housing 5, the damper 7 and the fixing device cannot be unintentionally urged out of the opening 15 when a heavy loading is involved. The two first support portions 12 are mounted substantially laterally with respect to the per se known worm 9 for depth adjustment. Otherwise the hinge itself and in particular the intermediate portion 8 and the gap adjusting screw 10 are designed in this embodiment as is known in the state of the art.

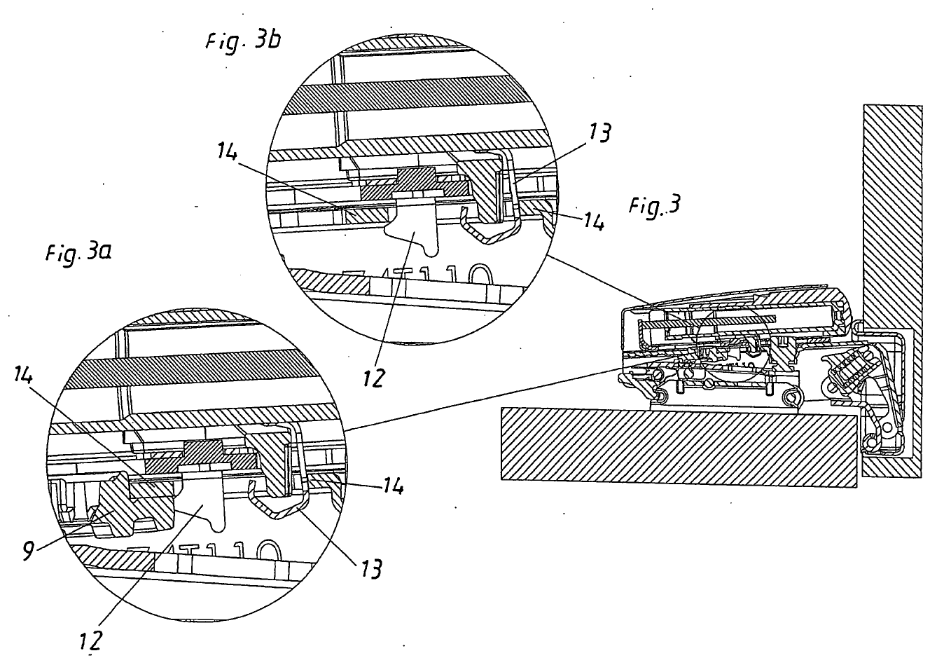

The detail view in FIG. 3a shows a portion from FIG. 3 on an enlarged scale. The worm 9 is omitted in FIG. 3b in order better to show the first support portion 12 engaging behind the edge 14. FIG. 3 is a view of FIG. 2 on a reduced scale.

To dismantle the damper unit the housing 5 is pressed in the direction 24 against the spring force of the second support portion 13 until the first support portions 12 are free and the entire unit can be withdrawn upwardly, that is to say in opposite relationship to the arrow 23.

In a modification of the illustrated variant, the damper unit can also be mounted inclined slightly rearwardly or inclined slightly forwardly.

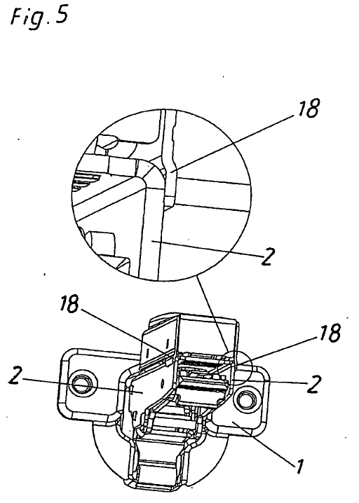

FIG. 4 shows an exploded view showing firstly the opening 15 with its edges 14 in the hinge arm 2. The lower portion 5a and the upper portion 5b of the housing are also shown separated from each other. The laterally formed third support portions 18 can be clearly seen on the upper portion 5b of the housing, the function of which third support portions can be particularly clearly seen by reference to FIG. 5. They embrace the hinge arm 2 in such a way that the damper housing, in the condition of being fitted onto the hinge arm 2, cannot be inadvertently pressed down off the hinge arm by application of a lateral force. That method of additional positioning also secures the damper unit to prevent rotation.

FIG. 4 once again shows the rubber buffer 17 which in an advantageous variant is fitted in the plunger 6 and prevents hard impact against the movable constituent part 1 of the article of furniture.

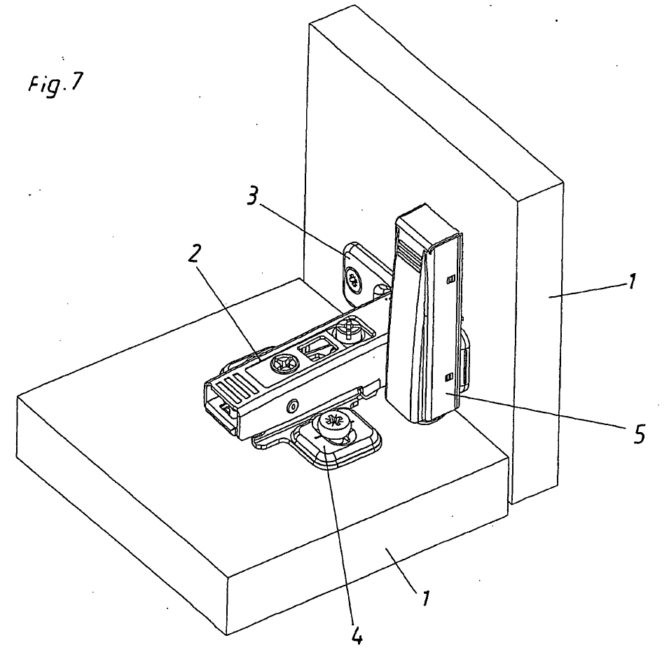

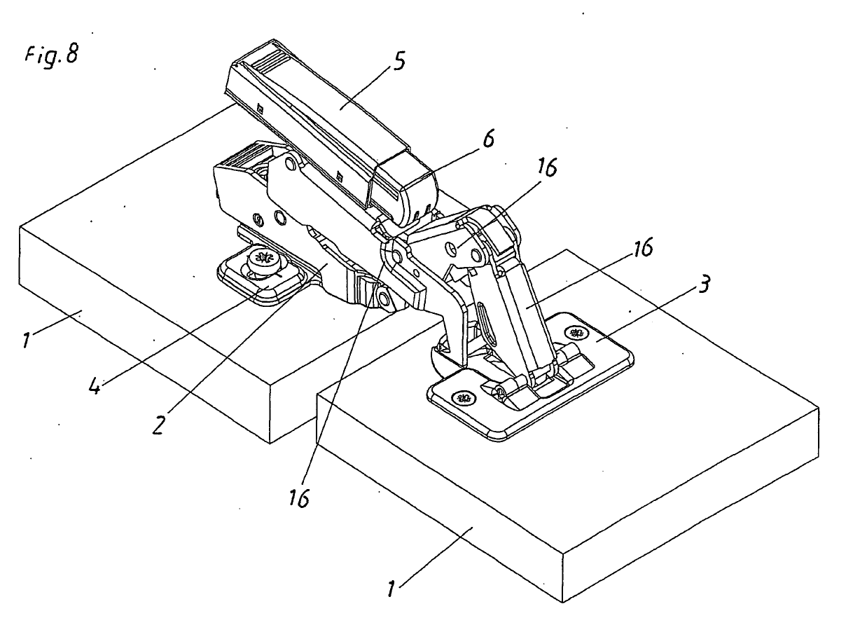

FIG. 6 shows a second embodiment. Here the damper housing 5 is fixed laterally to the hinge arm 2. FIG. 7 shows by way of example that the damper housing can also be fixed to the hinge cup 3 or another second fitment portion. The embodiment of FIG. 8 shows a so-called and per se known wide-angle hinge in which the damper housing is fitted onto a hinge lever 16 by means of a fixing device 11 which is in accordance with the invention but which is not visible here. The hinge lever 16 is supported pivotably with respect to the hinge arm 2. The plunger 6 in this embodiment is supported against a further hinge lever 16. In all the embodiments of FIGS. 6 through 8 the fixing device according to the invention can be designed as in the first embodiment shown in FIGS. 1 through 5. The openings 15 into which the fixing device 11 engages are then to be provided on the respective part of the hinge, that is to say on one of the fitment portions 2 and 3, on the corresponding hinge lever, or also on an intermediate portion 8. The other way round however it is also possible for the fixing device 11 to be arranged on one of the fitment portions 2, 3, a hinge lever 16 or an optionally provided intermediate portion 8.

1. An arrangement comprising:
a furniture hinge,
a damper,
said damper or a damper housing carrying said damper can be fitted onto said hinge by means of a fixing device which is at least region-wise elastic,
wherein said fixing device has at least one substantially rigid first support portion and at least one substantially resilient or spring-loaded second support portion.

2. The arrangement according to claim 1, wherein said fixing device can be actuated without a tool or by hand.

3. The arrangement according to claim 1, wherein a spring force acting on said second support portion loads said second support portion in a direction facing away from said first support portion.

4. The arrangement according to claim 1, wherein said first support portion is of a substantially hooked configuration or has at least two hooks.

5. The arrangement according to claim 1, wherein said second support portion has a spring tongue.

6. The arrangement according to claim 1, wherein said damper when being loaded in operation, said damper or said damper housing is supported on said hinge substantially by way of said first support portion.

7. The arrangement according to claim 1, wherein said hinge or said damper or said damper housing has an opening into which said fixing device can engage.

8. The arrangement according to claim 7, wherein said opening has a substantially rigid edge.

9. The arrangement according to claim 7, wherein said hinge comprises at least two fitment portions and at least one hinge lever hingedly connecting said fitment portions, wherein said opening is provided in one of said fitment portions or in said hinge lever and said fixing device is provided or fixed on said damper or on said damper housing or formed integrally on said damper or on said damper housing.

10. The arrangement according to claim 9, wherein said at least two fitment portions are designed as a hinge arm and a hinge cup.

11. The arrangement according to claim 9, wherein said hinge comprises at least one intermediate portion arranged between one of said fitments portions and one of said furniture parts.

12. The arrangement according to claim 11, wherein said opening is provided on said intermediate portion.

13. The arrangement according to claim 7, wherein said hinge comprises at least two fitment portions and at least one hinge lever hingedly connecting said fitment portions, wherein said opening is provided in said damper or said damper housing and said fixing device is provided or fixed on one of said fitment portions or on said hinge lever.

14. The arrangement according to claim 13, wherein said at least two fitment portions are designed as a hinge arm and a hinge cup.

15. The arrangement according to claim 13, wherein said hinge comprises at least one intermediate portion arranged between one of said fitment portions and said furniture parts.

16. The arrangement according to claim 15, wherein said fixing device is arranged on said intermediate piece or formed integrally on said intermediate piece.

17. The arrangement according to claim 1, wherein there is additionally provided a third support portion for safeguarding against lateral displacement or against rotary movement.

18. A hinge having a fixing device suitable for an arrangement according to claim 1.

19. Damper or damper housing having a fixing device suitable for an arrangement according to claim 1.
